(19) United States
(12) Patent Application Publication
(10) Pub. No.: US 2014/0154519 A1
(43) Pub. Date: Jun. 5, 2014

(54) NON-AQUEOUS COMPOSITION COMPRISING PARTIALLY FLUORINATED METHACRYLIC POLYMERS

(71) Applicant: E I DU PONT DE NEMOURS AND COMPANY, Wilmington, DE (US)

(72) Inventors: Michael Henry Ober, Newark, DE (US); John Christopher Sworen, Chadds Ford, PA (US); Ernest Byron Wysong, Hockessin, DE (US); Kathleen L. Kanetsky, New Castle, DE (US)

(73) Assignee: E I DU PONT DE NEMOURS AND COMPANY, Wilmington, DE (US)

(21) Appl. No.: 14/071,700

(22) Filed: Nov. 5, 2013

Related U.S. Application Data
(60) Provisional application No. 61/733,616, filed on Dec. 5, 2012.

(51) Int. Cl. C09D 133/14

(52) U.S. Cl. CPC C09D 133/14
USPC 428/540; 524/544; 427/427.6; 427/430.1; 427/429; 427/428.01; 427/440

(57) ABSTRACT

A solvent-based non-aqueous fluorinated methacrylate polymer comprising repeating units in any sequence from (1) at least one fluorinated methacrylate, and (2) at least one non-fluorinated alkyl acrylate and (3) at least one non-fluorinated hydroxyalkyl methacrylate,
provided that
a) the repeating unit of fluorinated methacrylate is present in a range of about 40%-80% by weight of total monomers added,
b) the repeating unit of non-fluorinated alkyl acrylate is present in a range of about 10%-35% by weight of total monomers added, and
c) the repeating unit of non-fluorinated hydroxyalkyl methacrylate is present in a range of about 5%-25% by weight of total monomers added, and
d) the total of all repeating units is 100% by weight.

### FIELD OF THE INVENTION

This invention relates to a stable, solvent based (i.e., non-aqueous) copolymer containing a fluorinated monomer, non-fluorinated monomer, hydroxyalkyl monomer, and an amino-containing monomer, the manufacture thereof, and the methods of use thereof on hard surface substrates to provide water and oil repellency, and stain resistance.

### BACKGROUND OF THE INVENTION

Copolymers containing fluorochemical pendant groups have been used as surface protectants for treated substrates such as hard surfaces and leathers substrates. It is desirable to dissolve these copolymers in various solvents to ease the application to substrates. Copolymers, such as those described by Ober et al. in U.S. Patent Application No. 20110200829, are a solvent based copolymer containing a fluorinated monomer, a non-fluorinated monomer and a hydroxyalkyl monomer useful for leather and hard surface substrates compared to the previously used aqueous based compounds. The compounds described by Ober et al., provided superior performance in non-aqueous solvents such as organic solvents, such as parrafins. It is also known that adding polar, aprotic solvents, such as isopropanol, as a co-solvent increases performance for stone and tile applications. For some applications, the addition of the co-solvent makes these polymers solution to become unstable over time. It is desired to have a copolymer useful for providing surface performance on stone and tile substrates that also maintains solution stability over time in dual solvent system. The present invention meets this need.

### SUMMARY OF THE INVENTION

The invention relates to a solvent-based fluorinated methacrylate polymer composition comprises repeating units in any sequence from (1) at least one fluorinated methacrylate, (2) at least one non-fluorinated alkyl acrylate, (3) at least one non-fluorinated hydroxyalkyl methacrylate, and 4) at least one amino-containing (meth)acrylate

provided that

a) the repeating unit of fluorinated methacrylate is present in a range of from 40% to 80% by weight of total monomers added,

b) the repeating unit of non-fluorinated alkyl acrylate is present in a range of from 10% to 35% by weight of total monomers added, and

c) the repeating unit of non-fluorinated hydroxyalkyl methacrylate is present in a range of from 5% to 25% by weight of total monomers added,

d) the repeating unit of the amino-containing (meth)acrylate is present in a range of from 0.5% to 15% by weight of total monomers added and

e) the total of all repeating units is 100% by weight.

### DETAILED DESCRIPTION

Herein trademarks are shown in upper case.

The term “(meth)acrylate” is used herein defined to mean both “acrylate” and “methacrylate”.

In the present invention, the concentration of the monomers a), b), c), and d) can be present at any concentration in the defined range. For example, the concentration of the repeating unit of fluorinated methacrylate is present in a range of from 40% to 80% by weight of total monomers added means that the concentration of the of the repeating unit of fluorinated methacrylate is present at 40%, 41%, 42%, . . . 78%, 79%, or 80%. The concentration of non-fluorinated alkyl acrylate is present 10%, 11%, 12%, 33%, 34%, or 35%. The concentration of non-fluorinated hydroxyalkyl methacrylate is present in a range of from 5%, 6%, 7%, 23%, 24%, or 25%. The concentration of amino-containing (meth)acrylate is present at 0.5%, 0.6%, 0.7%, 13.5%, 14.0%, 14.5%, or 15%. The total concentration of each monomer is selected such that the total sum is equal to 100%.

The present invent relates to a solvent-based fluorinated methacrylate polymer composition comprises repeating units in any sequence from (1) at least one fluorinated methacrylate, (2) at least one non-fluorinated alkyl acrylate, (3) at least one non-fluorinated hydroxyalkyl methacrylate, and 4) at least one amino-containing (meth)acrylate

provided that

a) the repeating unit of fluorinated methacrylate is present in a range of from 40% to 80% by weight of total monomers added,

b) the repeating unit of non-fluorinated alkyl acrylate is present in a range of from 10% to 35% by weight of total monomers added, and

c) the repeating unit of non-fluorinated hydroxyalkyl methacrylate is present in a range of from 5% to 25% by weight of total monomers added,

d) the repeating unit of the amino-containing (meth)acrylate is present in a range of from 0.5% to 15% by weight of total monomers added and

e) the total of all repeating units is 100% by weight.

The above solvent-based fluorinated methacrylate polymer is prepared polymerization of fluorinated methacrylate monomer with other monomers as detailed below. In a preferred embodiment, the polymer excludes any repeating units derived from vinylidene chloride.

The fluorinated methacrylate monomers preferred for the use in the present invention are of formula (I)

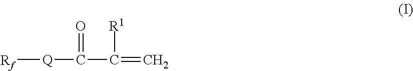

where R_{f} is C₂ to C₁₀ fluoroalkyl optionally interrupted by 1 to 3 —O—, —CH₂—, —CHF—, or combinations thereof;

Q is —R²-A-, —SO₂—N(R²)—R²—O—, —CO—N(R³)—R²—O—, —CH₂CH(OR³)CH—O—, —R²—SO₂—N(R³)—O—, or —R²—O—C(O)—N(R³)—R²—O—;

A is O or S;

R¹ is CH₃;

R² is C1 to C10 alkylene; and

R³ is H or C₁ to C₄ acyl.

Examples of R_{f} include, but are not limited to, CF₃(CF₂)ₓ—, CF₃(CF₂)ₓ(CH₂CF₂)_{y}—, CF₃(CF₂)_{y}O(CF₂)_{y}—, and CF₃(CF₂)_{y}OCFH(CF₂)_{z}—, wherein each x is independently 1 to 9, each y is independently 1 to 3, and each z is independently 1 to 4. Preferably, R_{f} is C₂ to C₆ fluoroalkyl, more preferably, R_{f} is C₆ fluoroalkyl. Preferably, Q is —R²-A-, and R¹ is H or CH₃. More preferably, R² is C₂ alkylene, and A is O.

Fluorinated methacrylates of Formula (I) are synthesized from the corresponding alcohols. These fluorinated methacrylate compounds are prepared by either esterification of the corresponding alcohol with acrylic acid or methacrylic acid or by transesterification with methyl(meth)acrylate or methyl(meth)acrylate. These preparations are well known and are described in U.S. Pat. No. 3,282,905, herein incorporated by reference.

Fluorinated methacrylates useful in the present invention are prepared from alcohols having the formula CF₃(CF₂)ₓ(CH₂)ₙOH wherein each x is individually 1 to 9 and n is an integer from 1 to 10, are commercially available from E. I. du Pont de Nemours and Company, Wilmington, Del. These alcohols are also prepared by reaction of the corresponding perfluoroalkyl iodies with oleum and hydrolyzed according to the procedure described in WO 95/11877, herein incorporated by reference. These alcohols are available as a homologue distribution mixture or are fraction distilled into individual chain lengths. Preferably, n is 2 to 6, more preferably n is 2.

Fluorinated (meth)acrylates useful in the present invention are prepared from alcohols having the formula CF₃(CF₂)ₓ(CH₂CF₂)ₚ(CH₂)ₙOH wherein each x is independently 1 to 4, each p is independently 1 to 2, and n is an integer from 1 to 10. These alcohols are prepared by the telomerization of perfluoroalkyl iodides with vinylidene fluoride followed by ethylene insertion. A detailed description of the vinylidene fluoride reaction is described in Balague, et al., “Synthesis of Fluorinated telomers, Part 1, Telomerization of vinylidene fluoride with perfluoroalkyl iodides”, J. Fluor. Chem. (1995), 70(2), 215-23. Reaction details for the ethylene insertion reaction are described in U.S. Pat. No. 3,979,469. The alcohols are prepared with oleum and hydrolysis as described above. Preferably, n is 2 to 6, more preferably n is 2.

Fluorinated methacrylates useful in the present invention are prepared from alcohols having the formula CF₃(CF₂)_{y}O(CF₂)_{y}(CH₂)ₙOH wherein each y is independently 1 to 3 and n is an integer of 1 to 10. These alcohols are prepared from the corresponding perfluoroalkyl ether iodides, of formula CF₃(CF₂)_{y}O(CF₂)_{y}I wherein each y is independently 1 to 3. These iodides are prepared according to the procedure described in U.S. Pat. No. 5,481,028, hereby incorporated by reference, by reacting a perfluorovinyl ether with ICI/HF and BF₃. Ethylene insertion and alcohol conversion is as described above. Preferably, n is 2 to 6, more preferably n is 2.

The above fluorinated methacrylate monomers are available either from Sigma-Aldrich (St. Louis, Mo.) or from E. I. du Pont de Nemours and Company (Wilmington, Del.).

The nonfluorinated alkyl acrylate monomers suitable for the use in the present invention comprise alkyl acrylates in which the alkyl group is a straight or branched chain containing 8 to 40 carbon atoms, or mixtures thereof and are of formula (II):

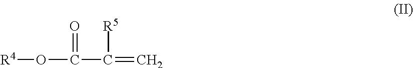

where R⁴ is C₈ to C₄₀ linear or branched alkyl; and

R⁵ is H.

The preferred alkyl group for the alkyl acrylates contains 8 to 20 carbon atoms. The alkyl acrylates (linear or branched) are exemplified by, but not limited to, alkyl acrylates where the alkyl group is octyl, 2-ethylhexyl, decyl, isodecyl, lauryl, cetyl, or stearyl. The preferred examples are 2-ethylhexyl(meth)acrylate, lauryl(meth)acrylate and stearyl acrylate.

The hydroxyalkyl methacrylate monomers preferred in the present invention comprise alkyl chain lengths in the range between 2 and 4 carbon atoms and are of formula (III),

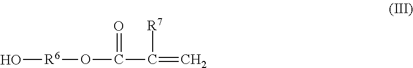

where R⁶ is C₂ to C₄ alkyl; and

R⁷ is CH₃.

The preferred hydroxyalkyl methacrylate is 2-hydroxyethyl methacrylate.

The amino-containing (meth)acrylates monomers preferred for the use in the present invention comprise dialkyl amino groups and are of formula (IV):

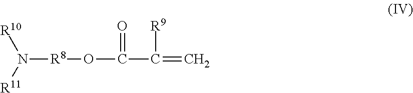

wherein

R⁸ is an ethylene or propylene group;

R⁹ is H or CH₃;

R¹⁰ and R¹¹ are each independently methyl, ethyl, or propyl groups. Preferred compounds of formula (IV) are dimethylaminoethyl(meth)acrylate and diethylaminoethyl(meth)acrylate.

The fluorinated co-polymers of the present invention are prepared in organic solvent by free radical initiated polymerization of a mixture of fluorinated methacrylate with the other monomers as listed above for each. The fluorinated polymers in this invention are made by agitating the monomers described above in organic solvent in a suitable reaction vessel which is equipped with an agitation device and an external heating and cooling device. A free radical initiator is added and the temperature can rise to from about 20° to about 70° C. The polymerization initiator is exemplified by 2,2′-azobis(2-methylbutanenitrile). These initiators are sold by E. I. du Pont de Nemours and Company, Wilmington, Del., commercially under the name of “VAZO”. An example of a suitable polymerization regulator or chain transfer agent is dodecyl mercaptan. Suitable organic solvents useful in the preparation of the polymers in the present invention include tetrahydrofuran, acetone, methyl isobutyl ketone, isopropanol, ethyl acetate, butyl acetate, and mixtures thereof. Butyl acetate is preferred. The reaction is conducted under an inert gas, such as nitrogen, to the exclusion of oxygen. The fluorinated co-polymers can be isolated by precipitation, and optionally purified by for example, recrystallization. After polymerization, the concentration of the resulting fluorinated co-polymers is generally diluted to about 35% by weight solids in butyl acetate and further diluted to about 2% by weight with either butyl acetate or a paraffin, such as mineral spirits. The about 2% by weight composition of the fluorinated co-polymers can then be applied to substrates to improve surface properties of the substrates, such as increased stain resistance. It is also surprisingly found that the fluorinated co-polymers are stable in dual solvent systems (co-solvents) compared to fluorinated co-polymers prepared that do not contain amino-containing (meth)acrylate repeat units.

The present invention further provides a method for treating a hard surface substrate comprising contacting the hard surface substrate with a solvent-based fluorinated methacrylate polymer composition to provide stain resistance wherein the fluorinated methacrylate polymer composition comprising repeating units in any sequence from (1) at least one fluorinated methacrylate, (2) at least one non-fluorinated alkyl acrylate, (3) at least one non-fluorinated hydroxyalkyl methacrylate, and 4) at least one amino-containing (meth)acrylate

provided that

a) the repeating unit of fluorinated methacrylate is present in a range of from 40% to 80% by weight of total monomers added,

b) the repeating unit of non-fluorinated alkyl acrylate is present in a range of from 10% to 35% by weight of total monomers added, and

c) the repeating unit of non-fluorinated hydroxyalkyl methacrylate is present in a range of from 5% to 25% by weight of total monomers

added,

d) the repeating unit of the amino-containing (meth)acrylate is present in a range of from 0.5% to 15% by weight of total monomers added and

e) the total of all repeating units is 100% by weight.

The term “hard surface”, as used herein, includes porous surfaces, such as stone, masonry, concrete, unglazed tile, brick, porous clay and various other substrates with surface porosity. Specific examples of such substrates include unglazed concrete, brick, tile, stone (including granite, limestone and marble), grout, mortar, statuary, monuments, wood, composite materials such as terrazzo, and wall and ceiling panels including those fabricated with gypsum board. These are used in the construction of buildings, roads, parking ramps, driveways, floorings, fireplaces, fireplace hearths, counter tops, and other decorative uses in interior and exterior applications.

The method of the present invention of treating a hard surface to provide water and oil repellency to the substrate comprises application of the composition described above to the substrate. The composition is applied to the substrate by contacting the composition with the substrate using conventional means, including but not limited to, spray, brush, roller, doctor blade, wipe, and dip techniques, preferably using a first coating, optionally followed by one additional coat using a wet-on-wet technique. More porous substrates may require subsequent additional coats. The wet-on-wet procedure comprises applying a first coat which is allowed to soak into the substrate but not dry (e.g., for about 10-30 minutes) and then applying a second coat. Any subsequent coats are applied using the same technique as described for the second coat. The substrate surface is then allowed to dry under ambient conditions, or the drying can be accelerated by warm air if desired. The wet-on-wet application procedure provides a means to distribute or build up more of the protective coating at the substrate surface. Spray and wet-on-wet applications are preferred. And spray application is most preferred.

The present invention further comprises substrates treated according to the method of the present invention. These substrates comprise porous surfaced materials used in interior and exterior construction applications. A wide variety of construction substrates are suitable for use herein. Examples of such materials include unglazed concrete, brick, tile, stone (including granite and limestone), grout, mortar, composite materials such as terrazzo, wall and ceiling panels including those fabricated with gypsum board, marble, statuary, monuments, and wood. The treated substrates have desired stain resistance properties.

Substrates treatable in the present invention vary widely in their porosity including less porous materials, such as granite or marble and more porous materials, such as limestone or Saltillo. The present invention is especially suitable for providing desired stain resistance to more porous substrates such as limestone or Saltillo. Thus limestone and Saltillo were tested in the Examples herein. A treatment that works well to provide stain resistance to more porous substrates will also work very well for less porous substrates, although the reverse is not true. The present invention provides stain resistance to more porous substrates while not altering their surface appearance.

### Test Methods

### Test Method 1

### Determination of Stain Resistance

Limestone (Walker Zanger Alhambra Limestone) tiles and Saltillo tiles of dimensions 12″×12″ tiles were treated and tested for stain resistance. The tiles were first rinsed under tap water and wiped dry. The tiles were then placed in a fan forced oven with a temperature setting of 60° C. for 2 hours. The tiles were removed and allowed to cool for a minimum of 15 minutes.

Treating solutions are made by diluting the compositions of the following examples from 35 weight % in butyl acetate to 2 weight % in mineral spirits. The compositions were then individually applied to separate tiles using a 1″ polyester bristle paint brush and allowed to dry for ten minutes before removing any excess liquid with the same brush. The treated tiles were placed into the oven at 60° C. for 60 minutes. The tiles were removed from the oven and allowed to cool for a minimum of 15 minutes. After cooling, the stain test analysis was performed. If applicable; the treated tile samples are allowed to sit for an additional 30 minutes before applying a subsequent coat. The process is repeated until the number of desired coats has been applied. Typically, two coats of product are applied to the substrate. The number of coats applied depends on the porosity of the substrate.

The following food stains were placed at intervals on the surface of the treated and dried limestone and Saltillo tiles and allowed to remain on the tile for 24 hours: 1) coke, 2) mustard, 3) bacon grease, 4) motor oil, 5) black coffee, 6) lemon juice, 7) grape juice, 8) ketchup, 9) Italian salad dressing, 10) canola oil.

After a 24-hour period, the food stains were blotted or lightly scraped from the tile surface. The tile's surface was rinsed with water and a stiff nylon bristle brush was used to scrub the surface to remove any remaining dried food residue. The tiles were then rinsed with water and allowed to dry for at least 24 hours before rating.

The stains remaining on the tile surfaces after cleaning were rated visually according to a scale of 0 to 4 as follows: 0=no stain; 1=very light stain; 2=light stain; 3=moderate stain; and 4=heavy stain. The ratings for each substrate type are summed for each of the stains to give a composite rating for each substrate. The maximum total score for each substrate was 10 stains times the maximum score of 4 per stain=40. Thus, the maximum composite score for both substrates (limestone and Saltillo) was two times the maximum score per substrate (40)=80. Lower scores indicate better stain protection with scores of 30 or less being acceptable and with zero indicating the best protection with no stain present.

### Test Method 2

### Stability Testing

The stability of the copolymers made below is tested in a dual solvent system. Compositions of the present invention were prepared as 35% solids in butyl acetate and diluted with mineral spirits to a final concentration of 2% solids. The solutions were then allowed to stand undisturbed for a period of seven days and observed for precipitation and/or gel formation. A pass rating was when no precipitation and/or gelled formed. A fail rating was given when there was at least some precipitation and/or some gel formation.

### EXAMPLES

### Example 1

A reactor was equipped with a water cooled condenser, thermocouple, overhead stirrer, and nitrogen sparge. A first solution of monomers stearyl acrylate (SA) (20.80 g), 2-hydroxyethyl methacrylate (HEMA) (2.75 g), CF₃(CF₂)₅CH₂CH₂OC(O)C(CH₃)CH₂ (35.0 g) in which is available from E. I. du Pont de Nemours and Company, Wilmington, Del., and 2-(diethylamino)ethyl methacrylate (DEAM) (0.35 g) in butyl acetate (61.91 g), were charged to the reactor. Reactor was heated to 50° C. with a sub-surface nitrogen sparged for 30 minutes and the agitator was set to 200 rpm. After 30 min sparge was switched to blanket. Temperature was raised to and held at 80° C. VAZO 67 (0.277 g, available from E. I. du Pont de Nemours and Company, Wilmington, Del.) in butyl acetate (7.254 g) was added to the beaker. Next, a second solution of monomers 2-hydroxyethyl methacrylate (8.18 g), CF₃(CF₂)₅CH₂CH₂OC(O)C(CH₃)CH₂ (11.40 g), and 2-(diethylamino)ethyl methacrylate (1.05 g) in butyl acetate (47.50 g), was added to the reactor over 3 hours. An additional solution of VAZO 67 (0.548 g) in butyl acetate (9.054 g) was added to the reactor during the addition of the second solution of monomers. The reactor was then cooled to ambient room temperature. Additional butyl acetate was added to the reactor and the mixture stirred for 30 min to provide a 35% solids. The above product was then tested for stain resistance according to Method 1 and for stability according to Test Method 2. The results were shown in table 5.

### Example 2

A copolymer dispersion was prepared as described in Example 1, except 2-(dimethylamino)ethyl methacrylate was used in place of 2-(diethylamino)ethyl(meth)acrylate. A reactor was equipped with a water cooled condenser, thermocouple, overhead stirrer, and nitrogen sparge. A first solution of monomers stearyl acrylate (SA) (20.80 g), 2-hydroxyethyl methacrylate (HEMA) (2.75 g), CF₃(CF₂)₅CH₂CH₂OC(O)C(CH₃)CH₂ (35.0 g), DE, and 2-(dimethylamino)ethyl methacrylate (DMAM) (0.35 g) in butyl acetate (61.91 g), were charged to the reactor. Reactor was heated to 50° C. with a sub-surface nitrogen sparged for 30 minutes and the agitator was set to 200 rpm. After 30 min sparge was switched to blanket. Temperature was raised to and held at 80° C. VAZO 67 (0.277 g) in butyl acetate (7.254 g) was added to the reactor. After the addition of the VAZO 67, a second solution of monomers 2-hydroxyethyl methacrylate (8.18 g), CF₃(CF₂)₅CH₂CH₂OC(O)C(CH₃)CH₂ (11.40 g), and 2-(dimethylamino)ethyl methacrylate (1.05 g) in butyl acetate (47.50 g), was added via syringe pump to the reactor over 3 hours. An additional solution of VAZO 67 (0.548 g) in butyl acetate (9.054 g) was added to the reactor during the addition of the second solution of monomers. After the addition of the second solution of monomers, the reactor was held for 3 hours and 45 minutes. The reactor was then cooled to ambient room temperature. Additional butyl acetate was added to the reactor and the mixture stirred for 30 min to provide a 35% solids. The above product was then tested for stain resistance according to Method 1 and for stability according to Test Method 2. The results were shown in table 5.

### Example 3

A copolymer dispersion was prepared as described in Example 1, except 2-(dimethylamino)ethyl methacrylate and 2-(diethylamino)ethyl methacrylate were used. A reactor was equipped with a water cooled condenser, thermocouple, overhead stirrer, and nitrogen sparge. A first solution of monomers stearyl acrylate (SA) (20.80 g), 2-hydroxyethyl methacrylate (HEMA) (2.75 g), CF₃(CF₂)₅CH₂CH₂OC(O)C(CH₃)CH₂ (35.0 g), 2-(diethylamino)ethyl methacrylate (0.35 g) and 2-(dimethylamino)ethyl methacrylate (0.35 g) in butyl acetate (61.91 g), was charged to the reactor. Reactor was heated to 50° C. with a sub-surface nitrogen sparged for 30 minutes and the agitator was set to 200 rpm. After 30 min sparge was switched to blanket. Temperature was raised to 80° C. and a first solution of VAZO 67 (0.277 g), in butyl acetate (7.254 g) was added. After the first addition of the VAZO 67, a second solution of monomers 2-hydroxyethyl methacrylate (8.18 g), CF₃(CF₂)₅CH₂CH₂OC(O)C(CH₃)CH₂ (11.40 g), 2-(diethylamino)ethyl methacrylate (1.05 g) and 2-(dimethylamino)ethyl methacrylate (1.05 g) in butyl acetate (47.50 g), was added via syringe pump to the reactor over 3 hours. An additional solution of VAZO 67 (0.548 g) in butyl acetate (9.054 g) was added to the reactor during the addition of the second solution of monomers. After the addition of the second solution of monomers, the reactor was held for 3 hours and 45 minutes. The reactor was then cooled to ambient room temperature. Additional butyl acetate was added to the reactor and the mixture stirred for 30 min to provide a 35% solids. The above product was then tested for stain resistance according to Method 1 and for stability according to Test Method 2. The results were shown in table 5.

### Example 4

A copolymer dispersion was prepared as described in Example 1, except 2-(diethylamino)ethyl methacrylate was present at 10% by weight. A reactor was equipped with a water cooled condenser, thermocouple, overhead stirrer, and nitrogen sparge. A first solution of monomers stearyl acrylate (SA) (20.80 g), 2-hydroxyethyl methacrylate (HEMA) (2.75 g), CF₃(CF₂)₅CH₂CH₂OC(O)C(CH₃)CH₂ (35.0 g), 2-(diethylamino)ethyl methacrylate (1.95 g) in butyl acetate (61.91 g), was charged to the reactor. Reactor was heated to 50° C. with a sub-surface nitrogen sparged for 30 minutes and the agitator was set to 200 rpm. After 30 min sparge was switched to blanket. Temperature was raised to 80° C. and a first solution of VAZO 67 (0.277 g), in butyl acetate (7.254 g) was added. After the first addition of the VAZO 67, a second solution of monomers 2-hydroxyethyl methacrylate (8.18 g), CF₃(CF₂)₅CH₂CH₂OC(O)C(CH₃)CH₂ (11.40 g), 2-(diethylamino)ethyl methacrylate (5.86 g) in butyl acetate (47.50 g), was added via syringe pump to the reactor over 3 hours. An additional solution of VAZO 67 (0.548 g) in butyl acetate (9.054 g) was added to the reactor during the addition of the second solution of monomers. After the addition of the second solution of monomers, the reactor was held for 3 hours and 45 minutes. The reactor was then cooled to ambient room temperature. Additional butyl acetate was added to the reactor and the mixture stirred for 30 min to provide a 35% solids. The above product was then tested for stain resistance according to Method 1 and for stability according to Test Method 2. The results were shown in table 5.

### Comparative Example A

A reactor was equipped with a water cooled condenser, thermocouple, overhead stirrer, and nitrogen sparge. A first solution of monomers stearyl acrylate (20.80 g), 2-hydroxyethyl methacrylate (2.75 g), and CF₃(CF₂)₅CH₂CH₂OC(O)C(CH₃)CH₂ (35.0 g) in butyl acetate (61.91 g) was charged to the reactor. Reactor was heated to 50° C. with a sub-surface nitrogen sparged for 30 minutes and the agitator was set to 200 rpm. After 30 min sparge was switched to blanket. Temperature was raised to 80° C. and a first solution of VAZO 67 (0.277 g), in butyl acetate (7.254 g) was added. After the first addition of the VAZO 67, a second solution of monomers 2-hydroxyethyl methacrylate (8.18 g), and CF₃(CF₂)₅CH₂CH₂OC(O)C(CH₃)CH₂ (11.40 g) in butyl acetate (47.50 g) was added via syringe pump to the reactor over 3 hours. An additional solution of VAZO 67 (0.548 g) in butyl acetate (9.054 g) was added to the reactor during the addition of the second solution of monomers. After the addition of the second solution of monomers, the reactor was held for 3 hours and 45 minutes. The reactor was then cooled to ambient room temperature. Additional butyl acetate was added to the reactor and the mixture stirred for 30 min to provide a 35% solids. The above product was then tested for stain resistance according to Method 1 and for stability according to Test Method 2. The results were shown in table 5.

### Example 5 to 10

Examples 5 to 10 were prepared as described in Example 4 at the concentrations of monomers fluorinated methacrylate, hydroxyethyl methacrylate, stearyl acrylate, 2-(diethylamino)ethyl methacrylate, and 2-(dimethylamino)ethyl methacrylate as listed in Table 1.

TABLE 1
Monomer concentrations for Examples 5 to 10

| | Concentration (weight %) | | | | | |
|---|---|---|---|---|---|---|
| Monomers | Ex 5 | Ex 6 | Ex 7 | Ex 8 | Ex 9 | Ex 10 |
| Fluorinated | 58.8 | 58.21 | 57.61 | 57.01 | 57.02 | 58.21 |
| methacrylate | | | | | | |
| Stearyl acrylate | 26.36 | 25.82 | 25.82 | 25.56 | 25.56 | 26.09 |
| Hydroxyethyl | 13.84 | 13.71 | 13.56 | 13.42 | 13.43 | 13.71 |
| methacrylate | | | | | | |
| 2-(Diethylamino)ethyl | 1 | 1.99 | 3 | 2 | 3.99 | 0 |
| methacrylate | | | | | | |
| 2-(Dimethylamino)ethyl | 0 | 0 | 0 | 2 | 0 | 1.99 |
| methacrylate | | | | | | |

The above products were then tested for stain resistance according to Method 1 for Saltillo only and for stability according to Test Method 2. The results were shown in table 5.

TABLE 2
Concentrations of the amino containing monomers, stain
resistance, and stability

| | | | Stain Rating | | |
|---|---|---|---|---|---|
| Example | % DEAM* | % DMAM* | Limestone | Saltillo | Stability |
| 1 | 1.8 | 0 | 17 | 15 | Y |
| 2 | 0 | 1.8 | 16 | 15 | Y |
| 3 | 1.8 | 1.8 | 11 | 13 | Y |
| 4 | 10 | 0 | 14 | 12 | Y |
| 5 | 1 | 0 | — | 21 | Y |
| 6 | 1.99 | 0 | — | 24 | Y |
| 7 | 3 | 0 | — | 19 | Y |
| 8 | 2 | 2 | — | 19 | Y |
| 9 | 3.99 | 0 | — | 17 | Y |
| 10 | 0 | 1.99 | — | 31 | Y |
| A | 0 | 0 | 15 | 33 | N |
| Untreated | 0 | 0 | — | 38 | — |

*DEAM = 2-(diethylamino)ethyl methacrylate
*DMAM = 2-(dimethylamino)ethyl methacrylate

As can be seen in Table 2, fluorinated copolymers of the present invention, comprising repeat units of fluorinated methacrylates, non-fluorinated alkyl acrylates, non-fluorinated hydroxyalkyl methacrylates, and amino-containing (meth)acrylates, are stable in a co-solvent system of butyl acetate and a parrafins which then can be applied to substrates such as limestone and Saltillo to provide improved stain resistance when compared to fluorinated co-polymers that do not contain amino-containing (meth)acrylates, such as in Comparative Example A. What can also be seen in Table 2 is the increasing the amount of the amino-containing (meth)acrylate provides improved performance.

What is claimed is:

1. A solvent-based non-aqueous fluorinated methacrylate polymer comprising repeating units in any sequence from (1) at least one fluorinated methacrylate, (2) at least one non-fluorinated alkyl acrylate, (3) at least one non-fluorinated hydroxyalkyl methacrylate, and 4) at least one amino-containing (meth)acrylate
provided that
a) the repeating unit of fluorinated methacrylate is present in a range of from 40% to 80% by weight of total monomers added,
b) the repeating unit of non-fluorinated alkyl acrylate is present in a range of from 10% to 35% by weight of total monomers added, and
c) the repeating unit of non-fluorinated hydroxyalkyl methacrylate is present in a range of from 5% to 25% by weight of total monomers added,
d) the repeating unit of the amino-containing (meth)acrylate is present in a range of from 0.5% to 15% by weight of total monomers added and
e) the total of all repeating units is 100% by weight.

2. The polymer of claim 1 wherein the fluorinated methacrylate is: 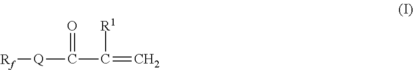
wherein R_{f} is C₂ to C₁₀ fluoroalkyl optionally interrupted by 1 to 3 —O—, —CH₂—, —CHF—, or combinations thereof;
Q is —R²-A-, —SO₂—N(R²)—R²—O—, —CO—N(R³)—R²—O—, —CH₂CH(OR³)CH—O—, —R²—SO₂—N(R³)—O—, or —R²—O—C(O)—N(R³)—R²—O—;
A is O or S;
R¹ is CH3;
R² is C1 to C10 alkylene; and
R³ is H or C₁ to C₄ acyl.

3. The polymer of claim 2 wherein R_{f} is C₂ to C₆, Q is —R²-A-, R1 is H or CH3.

4. The composition of claim 3, wherein R_{f} is C₆, R² is C₂ alkylene, and A is O.

5. The polymer of claim 1 wherein the non-fluorinated alkyl acrylate is: 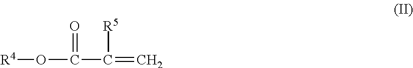
where R⁴ is C₈ to C₄₀ linear or branched alkyl; and R⁵ is H, or mixtures thereof.

6. The polymer of claim 5 wherein R⁴ is selected from the group consisting of octyl, 2-ethylhexyl, decyl, isodecyl, lauryl, cetyl, or stearyl.

7. The polymer of claim 5 wherein R⁴ is selected is selected from the group consisting of 2-ethylhexyl acrylate, lauryl acrylate and stearyl acrylate.

8. The polymer of claim 1 wherein the hydroxyalkyl methacrylate is 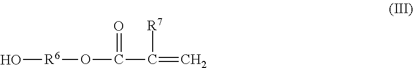
wherein R⁶ is C₂ to C₄ alkyl; and
R⁷ is CH₃ has an alkyl chain length in the range between 2 and 4 carbon atoms.

9. The polymer of claim 8 is 2-hydroxyethyl methacrylate.

10. The polymer of claim 1 wherein the amino-containing (meth)acrylate is: 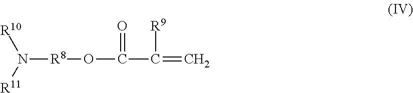
wherein R⁸ is an ethylene or propylene group;
R⁹ is H or CH₃;
R¹⁰ and R¹¹ are each independently methyl, ethyl, or propyl groups.

11. The polymer of claim 10, wherein the amino-containing (meth)acrylate is dimethylaminoethyl(meth)acrylate or diethylaminoethyl(meth)acrylate.

12. A method for treating a leather substrate comprising contacting the leather substrate with a solvent-based fluorinated methacrylate polymer to provide water and oil repellency, wherein the fluorinated methacrylate polymer comprises repeating units in any sequence from (1) at least one fluorinated methacrylate, (2) at least one non-fluorinated alkyl acrylate, (3) at least one non-fluorinated hydroxyalkyl methacrylate, and 4) at least one amino-containing (meth)acrylate, provided that
a) the repeating unit of fluorinated methacrylate is present in a range of from 40% to 80% by weight of total monomers added,
b) the repeating unit of non-fluorinated alkyl acrylate is present in a range of from 10% to 35% by weight of total monomers added, and
c) the repeating unit of non-fluorinated hydroxyalkyl methacrylate is present in a range of from 5% to 25% by weight of total monomers added,
d) the repeating unit of the amino-containing (meth)acrylate is present in a range of from 1% to 20% by weight of total monomers added and
e) the total of all repeating units is 100% by weight.

13. The method of claim 12 wherein the contacting is by spray, dipping, foam, nip, immersion, brush, roller, sponge, mat techniques.

14. The method of claim 12 wherein the contacting is by spray, dipping, and brush techniques.

15. A method for treating a hard surface substrate comprises contacting the hard surface substrate with a solvent-based fluorinated methacrylate polymer to provide water repellency, oil repellency, and stain resistance wherein the fluorinated methacrylate polymer comprises repeating units in any sequence from (1) at least one fluorinated methacrylate, (2) at least one non-fluorinated alkyl acrylate, (3) at least one non-fluorinated hydroxyalkyl methacrylate, and 4) at least one amino-containing (meth)acrylate,
provided that
a) the repeating unit of fluorinated methacrylate is present in a range of from 40% to 80% by weight of total monomers added,
b) the repeating unit of non-fluorinated alkyl acrylate is present in a range of from 10% to 35% by weight of total monomers added, and
c) the repeating unit of non-fluorinated hydroxyalkyl methacrylate is present in a range of from 5% to 25% by weight of total monomers added,
d) the repeating unit of the amino-containing (meth)acrylate is present in a range of from 1% to 20% by weight of total monomers added and
e) the total of all repeating units is 100% by weight.

16. The method of claim 15 wherein the contacting is by brush, spray, roller, doctor blade, wipe and dip techniques.

17. The method of claim 15 wherein the contacting is by spray and wet-on-wet techniques.

18. The method of claim 15 wherein the hard surface substrate is unglazed concrete, brick, tile, stone, granite, limestone, grout, mortar, composite materials, terrazzo, gypsum board, marble, statuary, monuments, or wood.

19. A substrate treated with the method of claim 14 which is unglazed concrete, brick, tile, stone, granite, limestone, grout, mortar, composite materials, terrazzo, gypsum board, marble, statuary, monuments, or wood.

20. The polymer of claim 1 wherein the polymer excludes any repeating units derived from vinylidene chloride.
